(19) United States
(12) Patent Application Publication
(10) Pub. No.: US 2011/0016049 A1
(43) Pub. Date: Jan. 20, 2011

(54) ACCOUNT RISK MANAGEMENT AND AUTHORIZATION SYSTEM FOR PREVENTING UNAUTHORIZED USAGE OF ACCOUNTS

(76) Inventor: Craig Patrick Kilfoil, Country Cork (IE)

Correspondence Address: CHARTER IP, LLC, P.O. BOX 64, The Plains, VA, 20198, US

(21) Appl. No.: 12/747,187

(22) PCT Filed: Dec. 11, 2007
(86) PCT No.: PCT/IB07/55015

§ 371 Date: Sep. 14, 2010

(51) Int. Cl. G06Q 40/00

(52) U.S. Cl. 705/44

(57) ABSTRACT

The invention provides a system for maintaining approval criteria of one or more accounts as determined by an account holder, said system including a server capable of maintaining the approval criteria of an account over its lifecycle, a server capable of determining whether a transaction against an account is permissible based on a set of account holder selected approval criteria, an interface accessible over a local or wide area network configured to permit an issuer system to request permission to proceed with its own authorization processing upon receipt of an authorization request against an account, an interface accessible over a local or wide area network configured to permit an account holder or an authorized account operator to instruct the server to allow or disallow transactions based on the variable approval criteria selected by the account holder, and a system for authenticating a user prior to permitting operations to be processed on the server in response to commands from the account holder.

### FIELD OF THE INVENTION

The invention relates to a system which allows account holders, account providers or an authorized account operator to prevent unauthorized usage of an account.

### BACKGROUND TO THE INVENTION

### Definitions:

“Accounts” refer to money accounts such as savings accounts, call accounts, cheque accounts, current accounts, association branded or proprietary credit or debit card accounts, accounts with a merchant or a service provider which reflect a monetary value;

Presently, a significant amount of fraud is perpetrated through unauthorized access to accounts including bank accounts and card accounts, the majority as a result of stolen identity credentials and credit or debit cards being copied or “skimmed”.

While financial institutions, credit card associations and card issuers have deployed authentication security systems to prevent unauthorized access to payment instruments many are in-effective and others costly to implement. For example, Smart Cards, recognized as the most secure card payment technology to prevent card skimming, while effective are costly.

It is further believed that a significant amount of internet banking fraud and card fraud is committed as a result of log-in credentials or payment card details being compromised and thereafter used to transfer funds or for internet purchases, for unauthorized mail-order telephone-order purchases and card-present fraud.

Thus, there exists a need to increase the security on payment instruments and accounts that allow the account holder remote access to an authorization system through a simple and affordable method using devices and channels readily accessible to most account holders.

It is believed that these and other deficiencies in internet banking, payments systems, banking systems and the card payments industry are addressed by the present invention.

### SUMMARY OF THE INVENTION

According to a first aspect of the invention, there is provided a system for maintaining approval criteria of one or more accounts as determined by an account holder or account provider, said system including:
a server capable of maintaining the approval criteria of an account over its lifecycle;
a server capable of determining whether a transaction against an account is permissible based on a set of pre-selected approval criteria;
an interface accessible over a local or wide area network configured to permit an issuer system to request permission to proceed with its own authorization processing upon receipt of an authorization request against an account;
an interface accessible over a local or wide area network configured to permit an account holder or an authorized account operator to instruct the server to allow or disallow transactions based on the variable approval criteria selected by the account holder; and
a system for authenticating a user prior to permitting operations to be processed on the server in response to commands from the account holder.

According to a second aspect of the invention, there is provided a system which accepts instructions from account holders for conditionally allowing access to, or authorization to deduct funds from, one or more accounts, said system including:
a server capable of determining whether a transaction against an account is permissible based on a set of account selected approval criteria;
an interface accessible over a local or wide area network configured to permit an issuer system to request permission to proceed with its own authorization processing upon receipt of an authorization request against an account
an interface accessible over a local or wide area network configured to permit an account holder or an authorized account operator to instruct the server to allow or disallow transactions based on the variable approval criteria selected by the account holder;
a system for authenticating a user prior to permitting operations to be processed on the server in response to commands from the account holder; and
a system and interface allowing the account holder or an authorized account operator to query and change the approval criteria.

Thus, in an embodiment, the invention provides an internet website through the use of which account holders or card holders can instruct the server.

In an embodiment, the invention provides an administration interface through the use of which account providers can instruct the server.

Thus, for example, the invention may permit the account holder or account provider to set transaction limits such as maximum values, maximum counts, all of, some or none based on defined approval criteria.

The wide area network may thus be the world wide web, a mobile telecommunication network, and the like.

The invention extends to permitting an account holder to modify the approval criteria of the financial account via a mobile device.

The invention extends further to a system for controlling the approval criteria for an account, the system comprising:
a secure internet website and/or internet banking website;
access points that accept messages from mobile phones via various channels including:
   WAP (Wireless Application Protocol)
   USSD (Unstructured Supplementary Service Data)
   SMS/Text (Short Message Service)
   MMS (Multimedia Message Service)
   STK (SIM Application Toolkit)
   WIG (Wireless Internet Gateway)
   Smartphone application;
an IVR (Interactive Voice Response) system; and
optionally, one or more of the following:
   an application running on a financial point-of-sale, self service or ATM terminal;
   an authentication system to validate the identity of the true user/owner of an account;
   an interface to an external authentication system to validate the identity of the true user/owner of an account;
   an interface for the system to generate messages to the account holder relating to the approval criteria of the account;
   message notifications to account holders as a result of authorized or unauthorized transactions allowed against the account based on the approval criteria; and
   a switching mechanism to stand between external authorization interfaces and an account system.
   An administration interface internal to or external to the account provider

The system may be configured to originate a message to the account holder based on the transaction success or failure relative to approval criteria selected by the account holder.

The system may generate a request to the account holder upon declining a transaction authorization, to allow for alteration of approval criteria to allow approval of a further authorization attempt against the account based on a previously declined transaction.

The account holder may reply from an access device with a PIN or password which is validated by the system.

The invention further provides a method for the account holder or an authorized account operator to configure the system to automatically control authorizations in reaction to predetermined events or activities on the account.

Thus, for example, the account holder or an authorized account operator may configure the system to selectively authorize or decline transactions or alter the approval criteria, if one or more of the following events occur:
effluxion of a pre-selected time period;
attempt from an external system to process an unexpected transaction;
a pre-selected volume of transactions;
when a transaction exceeds a certain monetary value;
transactions originating from the Internet; and/or
transactions received from merchant pre-selected types that fall into a category selected by the account holder, such as alcohol, adult content and/or pharmaceuticals.
when a transaction is below a certain monetary value;
when a transaction is from a certain country, continent or region;
when the transaction is processed in a certain currency;
within certain date/time parameters; and
based on a particular balance or balance available on account.

An embodiment of the invention provides for the system to originate a message to the account holder or an authorized account operator suggesting a transaction was declined from a certain payee allowing the account holder to reconfigure the approval criteria as to permit the next identical transaction if represented by the payee.

### DESCRIPTION OF EMBODIMENTS OF THE INVENTION

The invention is described hereunder by way of an example which is not intended to limit the scope of the invention but only to provide an example of how the invention might be put into practice.

Technical Architecture A—Process flow of Account Permission System

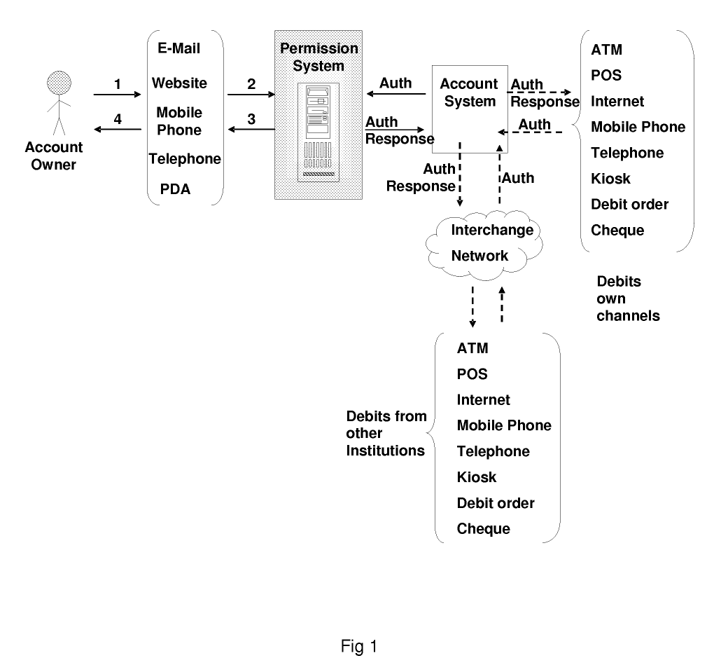

In Architecture A shown in FIG. 1 below, the Account Permission System acts as an authorization system that allows the Account system to check whether the account holder has granted permission for the transaction to be approved before it performs its own authorization processing.
1 Account holder accesses an Internet website or sends a message from a supported device, including e-Mail, Mobile Phone, Telephone or PDA to change permissions on the account.
2 The Account Permission System validates the identity of the account holder or the account holder device sending the message. The Account Permission System records the change in account permissions.
3 Optionally, the Account Permission system communicates with the account holder as to the status of permissions on the account and/or transactional activity on the account.
4 Account holder is notified via the chosen channel of communications including e-Mail and/or SMS.

When a financial authorization hits the account system, it first presents the data to the Account Permission System to check account holder permissions, before processing its own authorization logic. The account system may choose decline the authorization immediately upon response from the Account Permission System indicating that the permissions do not allow for the authorization to be approved.

The presentation of each authorization request to the Account Permission System allows the system to calculate velocities and other metrics that it may use as input to the approval criteria.

Technical Architecture B—Process flow Account Permission System

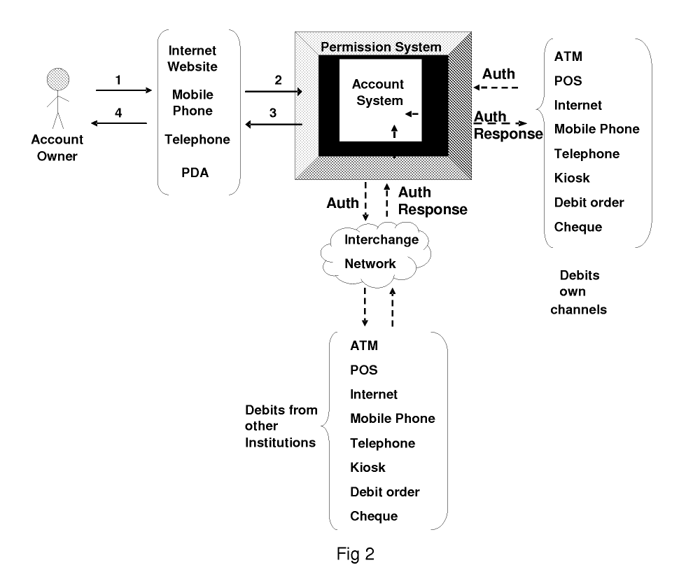

In Architecture B shown in FIG. 2, the Account Permission System intercepts authorization messages between external interfaces and the account system.
1 Account holder accesses an Internet website or sends a message from a supported device, including e-Mail, Mobile Phone, Telephone or PDA to change permissions on the account.
2 The Account Permission System validates the identity of the account holder or the account holder device sending the message. The Account Permission System records the change in account permissions.
3 Optionally, the Account Permission system communicates with the account holder as to the status of permissions on the account and/or transactional activity on the account.
4 Optionally, the Account holder is notified via the chosen channel of communications including e-Mail and/or SMS.

When a financial authorization hits the Account Permission System, it first checks account permissions, before passing the authorization to the account system for authorization. The Account Permission System may choose to decline the authorization immediately upon finding that the permissions do not allow for the authorization to be approved.

The presentation of each authorization request to the Account Permission System allows the system to calculate velocities and other metrics that it may use as input to the approval criteria.

1. A system for maintaining the approval criteria of one or more accounts as determined by the account holder, account provider or an authorized account operator, said system comprising:
a server capable of maintaining the approval criteria of an account over its lifecycle;
a server capable of determining whether a transaction against an account is permissible based on a set of account holder selected approval criteria;
an interface accessible over a local or wide area network configured to permit an issuer system to request permission to proceed with its own authorization processing upon receipt of an authorization request against an account;
an interface accessible over a local or wide area network configured to permit an account holder or an authorized account operator to instruct the server to allow or disallow transactions based on the variable approval criteria selected by the account holder; and
a system for authenticating a user prior to permitting operations to be processed on the server in response to commands from the account holder.

2. The system of claim 1, which system enables the account holder or an authorized account operator to carry out maintenance of the approval criteria on an account, the system including:
a secure internet website and/or internet banking website.

3. The system of claim 1, including access points that accept messages from mobile phones via various channels selected from the group including:
WAP (Wireless Application Protocol);
USSD (Unstructured Supplementary Service Data);
SMS/Text (Short Message Service);
MMS (Multimedia Message Service);
STK (SIM Application Toolkit);
WIG (Wireless Internet Gateway); and
Smartphone application.

4. The system of claim 1, further comprising an IVR (Interactive Voice Response) system.

5. The system of claim 1, further comprising an authentication system to validate the identity of the owner of an account.

6. The system of claim 1, further comprising a switching mechanism interposed between external authorization interfaces and an account system.

7. The system of claim 1, which system is configured to originate a message to the account holder based on the transaction success or failure relative to approval criteria selected by the account holder.

8. The system of claim 1, wherein the system generates a request to the account holder upon declining a transaction authorization, to allow for alteration of approval criteria to allow approval of a further authorization attempt against the account based on a previously declined transaction.

9. The system of claim 1, wherein the account holder replies from an access device with a PIN or password which is validated by the system.

10. A method for an account holder, account provider or an authorized account operator to configure the system of claim 1 to automatically change the approval criteria of an account in reaction to predetermined events or activities on the account, the method including setting the predetermined events or activities to one or more of the following:
effluxion of a pre-selected time period;
attempt from an external system to process an unexpected transaction;
a pre-selected volume of transactions;
pre-selected types of merchants based on the merchant category code;
when a transaction is below a certain monetary value;
when a transaction exceeds a certain monetary value;
when a transaction is from a certain country, continent or region;
when the transaction is processed in a certain currency;
within certain date/time parameters;
where the transaction originates from an Internet purchase; and
based on a particular balance or balance available on account.
